(19) United States
(12) Patent Application Publication
(10) Pub. No.: US 2022/0092601 A1
(43) Pub. Date: Mar. 24, 2022

(54) SYSTEM AND METHOD FOR ADDRESSING SPEAR PHISHING WITH REAL-TIME DATABASE IMPLEMENTATION

(71) Applicant: JPMorgan Chase Bank, N.A., New York, NY (US)

(72) Inventor: Ilya SLAVIN, Allen, TX (US)

(21) Appl. No.: 17/481,942

(22) Filed: Sep. 22, 2021

Related U.S. Application Data
(60) Provisional application No. 63/081,461, filed on Sep. 22, 2020.

(51) Int. Cl. G06Q 20/40; G06Q 20/02; G06Q 20/10; H04L 29/06

(52) U.S. Cl. CPC G06Q 20/4016; G06Q 20/407; H04L 63/1483; G06Q 20/108; G06Q 20/023

(57) ABSTRACT

The invention relates generally to a system and method that addresses spear phishing attempts. Embodiment of the present invention identifies messages that would have been blocked through a data loss prevention system and/or spam filters and further extracts financial directives (e.g., wire transfer information, account numbers, routing numbers, etc.). The extracted data may be stored and managed in a real-time database and used as a check for other transactions within the group, company and beyond.

### CROSS REFERENCE TO RELATED APPLICATIONS

The application claims priority to U.S. Provisional Application 63/081,461 (Attorney Docket No. 72167.001892), filed Sep. 22, 2020, the contents of which are incorporated by reference herein in its entirety.

### FIELD OF THE INVENTION

The invention relates generally to a system and method for addressing spear phishing attempts with a real-time database implementation, such as SnapCache.

### BACKGROUND OF THE INVENTION

Phishing schemes attempt to trick a target into giving up personal and financial information. Spear phishing is a highly targeted form of phishing. It generally involves an email targeted to a specific individual, organization or business.

With spear phishing, a perpetrator use social engineering to target someone into divulging passwords to an account, sharing access and/or other personal or sensitive information and performing other actions. This information could then be used to take over social media accounts as well as financial accounts. In other instances, scammers may target specific merchants, companies, government agencies and other entities. Spear phishing may be used to steal data as well as install malware on a target's computer or other device.

Because the targets are well researched, the emails are specific and personalized. This generates a level of trust and comfort and oftentimes results in targeted scam campaigns that are highly effective and difficult to address.

These and other drawbacks exist.

### SUMMARY OF THE INVENTION

According to an embodiment, the invention relates to a system that addresses spear phishing with a real-time database implementation, such as SnapCache. The system comprises: an interface that receives blocked information from a plurality of accounts; a real-time database that stores and manages blocked information; and a computer server that is coupled to the interface and the real-time database and further configured to perform the steps of: receiving results of blocked emails or communications from one or more data streaming sources; identifying financial directions from the blocked emails or communications; extracting account numbers and routing numbers from the financial directions; publishing, via a real-time database, the extracted account numbers and routing numbers in real-time as topics onto a shared data bus; enhancing the extracted account numbers and routing numbers with payloads and one or more details; determining whether an instruction contains data that matches the extracted account numbers and routing numbers stored in the real-time database; responsive to determining whether the instruction contains matched data, alerting one or more associated users of a potential attack; and performing analytics on the extracted account numbers and routing numbers.

According to another embodiment, the invention relates to a method that addresses spear phishing with a real-time database implementation, such as SnapCache. The method comprises the steps of: receiving, via an interface, results of blocked emails or communications from one or more data streaming sources; identifying, via a computer server, financial directions from the blocked emails or communications; extracting, via the computer server, account numbers and routing numbers from the financial directions; publishing, via a real-time database, the extracted account numbers and routing numbers in real-time as topics onto a shared data bus; enhancing, via the computer server, the extracted account numbers and routing numbers with payloads and one or more details; determining, via the computer server, whether an instruction contains data that matches the extracted account numbers and routing numbers stored in the real-time database; responsive to determining whether the instruction contains matched data, alerting one or more associated users of a potential attack; and performing, via the computer server, analytics on the extracted account numbers and routing numbers.

The system may include a specially programmed computer system comprising one or more computer processors, interactive interfaces, electronic storage devices, and networks. The computer implemented system, method and medium described herein provide unique advantages to entities, organizations and other users, according to various embodiments of the invention. Spear phishing tactics may involve adjusting messages to match specific destinations and/or recipients. Such tactics target high valued individuals as well as finance departments or other groups within a company. Oftentimes, these messages include a financial directive or a request for financial information. For example, a message may provide wire instructions or directions to change a current or future order or payment. In some instances, there may be a long duration between the initial communication and the actual fraud event. An embodiment of the present invention identifies messages that would have been blocked through a data loss prevention system and/or spam filters and then extracts financial directives (e.g., wire transfer information, account numbers, routing numbers, etc.) for at least some intended recipients. The extracted data may be stored and managed in a real-time database and used as a check for other transactions within the group, company and beyond.

These and other advantages will be described more fully in the following detailed description.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 is an exemplary flow diagram, according to an embodiment of the present invention.

FIG. 2 is an exemplary flow diagram, according to an embodiment of the present invention.

FIG. 3 is an exemplary system diagram, according to an embodiment of the present invention.

### DETAILED DESCRIPTION OF THE PREFERRED EMBODIMENT(S)

The following description is intended to convey an understanding of the present invention by providing specific embodiments and details. It is understood, however, that the present invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

Data loss prevention or spam detection technology may be implemented to identify unsolicited and unwanted communications. This may include detecting improper wire or Automated Clearing House (ACH) instructions emailed to a bank, a financial institution, or a service provider offering email services to their customers. Data loss prevention technology ensures that end users do not send critical or sensitive information outside a corporate network. Spam detection filters may use feedback and collective memory of a group of users to identify unwanted and unauthorized communications. When spam email or communications are received, an embodiment of the present invention may identify messages with directives and then use that information to improve and refine spam detection.

An embodiment of the present invention may extract destination account numbers and publish them in real-time as “topics” onto a shared data bus to a dedicated and highly locked down instance of a real-time database, such as SnapCache. For example, data sets may contain confidential information that would require strict access controls and monitoring. An embodiment of the present invention may further enhance the data with actual original email payload, headers, and/or relevant details that may be used for reference and refinement. SnapCache represents a real-time database that processes workloads whose states are constantly changing. With real-time databases, processing is performed quickly so that results may be acted on immediately. When dealing with financial transactions, a fast turnaround between detection and an ability to proactively prevent funds transfer is important. SnapCache is one example of a real-time database. Other real-time databases may be implemented in accordance with the various embodiments of the present invention.

Spear phishing generally sends targeted messages to high valued individuals as well as finance departments or other groups within a company. These messages may provide wire instructions or directions to change a current or future order or payment. In some scenarios, there may be a long duration between the initial communication and the actual fraud event.

For example, a commercial bank may analyze, in real-time or via batch processes, all wire directions from their clients. If any outbound wire matches one of the “topics” that were captured in the extraction step, an embodiment of the present may transmit an alert that a client is likely in the process of becoming a victim of an attack. Additional details concerning the communication may be provided for evidence and support to generate an appropriate response and/or action.

An embodiment of the present invention goes beyond current fraud detection tactics by treating wire instructions provided in spear phishing emails as streaming data. Rather than detect how a client arrived at a malicious site in order to intervene, which typically requires an ability to track client's movements on the Internet, an embodiment of the present invention may use wire instructions provided in targeted emails to identify a new pattern of attack. This may be designed to circumvent tracking of movements, rather than poisoning or compromising a client's contact list to facilitate a one-time, but high-value erroneous money transfer.

Spear phishing is an uncommonly successful pattern, use of which is on the rise by adversaries. It is increasing in sophistication, leading to higher success rates, and it has blossomed in the age of COVID, leading to many well-publicized disclosures. As attacks continue to increase and target a wider base of victims, a real-time repository of “bad” destinations may function like a “black hole” email list to circumvent or prevent email traffic from being accepted from compromised domains.

An embodiment of the present invention identifies messages that would have been blocked through a data loss prevention system and/or spam filters and further extracts financial directives (e.g., wire transfer information, account numbers, routing numbers, etc.). Other types of transactions may include Swift, Bitcoin, cryptocurrencies, other digital currencies and transactions, etc. The extracted data may be stored and managed in a real-time database and used as a check for other transactions within the group, company and beyond. For example, when a client of a financial institution has been targeted, it is likely that other clients as well as contacts within the financial institution have also been targeted or otherwise contacted.

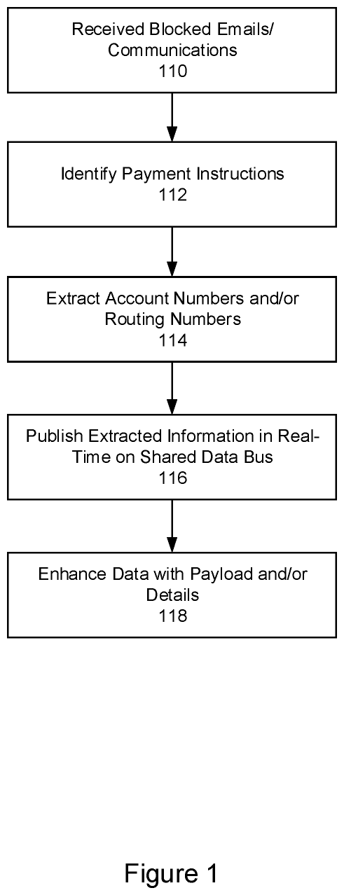

FIG. 1 is an exemplary flowchart, according to an embodiment of the present invention. At step 110, an embodiment of the present invention receives results of blocked emails and/or communications. At step 112, wire instructions may be identified from the blocked emails or communications. At step 114, account numbers/routing numbers may be extracted. At step 116, the extracted information may be published in real-time as topics onto a shared data bus. At step 118, the data may be enhanced with payload and details. While the process of FIG. 1 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 110, an embodiment of the present invention receives results of blocked emails and/or communications. The blocked emails or communications may be identified from an existing filtering or system that detects unsolicited and unwanted communications. Other communications may include text, voicemail, social media messaging, etc.

This data may be represented as streaming data which includes results of a data loss prevention system, data filter systems, etc. Multiple sources of data may be identified. The sources of data may be associated with a single entity. According to another example, the sources of data may be identified across multiple disparate entities and sources.

At step 112, payment instructions, such as wire instructions, may be identified from the blocked emails or communications. Wire instructions represent one example. Other financial directive information may be identified, such as ACH directives. An embodiment of the present invention may identify and extract wire instructions. Wire instructions may include recipient name, bank identifier, routing numbers, account numbers, etc.

At step 114, account numbers and/or routing numbers may be extracted. Other account and/or destination information may be extracted. An embodiment of the present invention seeks to address this information as data and further apply analytics for refinement and feedback.

At step 116, the extracted information may be published in real-time as topics onto a shared data bus. Additional information may be captured including whether the extracted information has been acted on. This may include an attempt to make a payment using the extracted information. This may also involve interacting with a website or other interface to make a payment or inquire further. Other attempts or interactions may be identified and captured.

At step 118, the data may be enhanced with payload and details. Additional payload and details may include the underlying text or body of the message. Other details may include headers, key value pairs, day and time sent, etc. The payload data may be used when contacting a potential victim to provide evidence and support for the unsolicited communication. In addition, the payload data may be used to identify and further prevent other similar attempts.

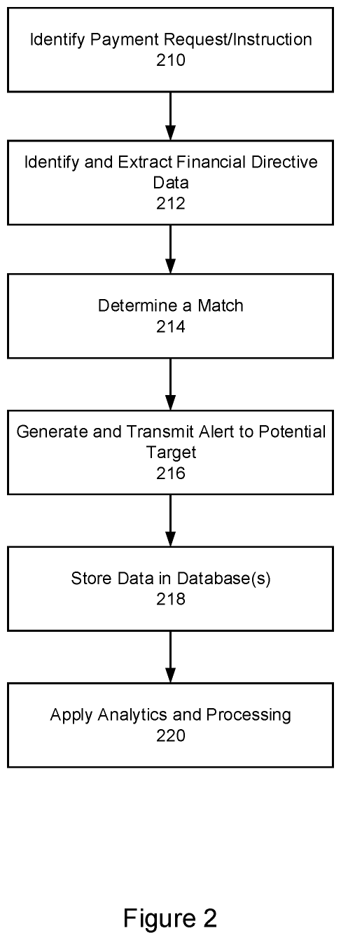

FIG. 2 is an exemplary flow diagram, according to an embodiment of the present invention. At step 210, a payment request or instruction may be identified. At step 212, financial directive data may be identified and extracted. At step 214, an embodiment of the present invention may determine whether a match has occurred. At step 216, based on the match, a potential target, victim or customer may be identified and then contacted. At step 218, corresponding data may be stored. At step 220, analytics and processing may be performed to further refine the process for a single source of data or across multiple streams of data. While the process of FIG. 2 illustrates certain steps performed in a particular order, it should be understood that the embodiments of the present invention may be practiced by adding one or more steps to the processes, omitting steps within the processes and/or altering the order in which one or more steps are performed. Additional details for each step are provided below.

At step 210, a payment request or instruction may be identified. The payment request may relate to a wire transaction, ACH and/or other instruction.

At step 212, financial directive data may be identified and extracted. The financial directive data may provide directions relating to financial accounts, payment and/or other transaction. The financial directive data may be analyzed in real-time or batch.

At step 214, an embodiment of the present invention may determine whether a match has occurred. An embodiment of the present invention may determine whether extracted numbers were used in other unsolicited attempts for unauthorized sources.

An embodiment of the present invention may verify or check aspects of a wire instruction with data extracted from blocked messages. For example, the system may check routing numbers, account numbers and/or other data to verify whether the information was used in a prior phishing attempt. Other common attributes may be detected.

At step 216, based on the match, a potential target, victim or customer may be identified and then contacted. For example, if a match is detected, an embodiment of the present invention may then alert a customer or recipient of a potential phishing attempt. The alert may further include supporting data, e.g., a similar message involving the same account number was used in a scam. The alert may specify where the message came from, who it was sent to in a prior communication, what the message said, when the prior attempts occurred, etc.

An embodiment of the present invention may include an interface that enables a user, or an Application Programming Interface (API) to verify wire transfers prior to executing or acting on a directive.

Upon identifying wire directions (including routing number and account number, for example), an embodiment of the present invention may further contact banks to alert original owners of the account and address an origination of the phishing attempt. Other preventative measures may be taken.

At step 218, corresponding data may be stored. Data may be stored and managed in one or more databases. Data may relate to attributes and specifics relating to potential fraud attacks. In addition, a user may search for data relating to any prior activity relating to wire instructions using account information and/or other identifier. This provides additional insights as to the type of communication made and whether any action has been taken. For example, a user may search for any activity relating to a wire instruction to determine whether the instructions were part of a prior phishing attempt.

At step 220, analytics and processing may be performed to further refine the process for a single source of data or across multiple streams of data.

The embodiments of the present invention may be implemented in various system architectures. For example, an embodiment of the present invention may be implemented as a centralized service that multiple entities (e.g., banks, financial institutions, etc.) may contribute to and participate in. In this scenario, multiple banks may identify blocked messages and extract financial information. The extracted information may be mined, analyzed and managed in one or more real-time databases at a centralized location. Other participants, including the contributing banks, may then use the managed information to identify potential spear phishing communications that contain the extracted data. The system could be further enhanced by email service providers performing or supporting the detection steps of FIG. 1 and sharing their findings with financial entities.

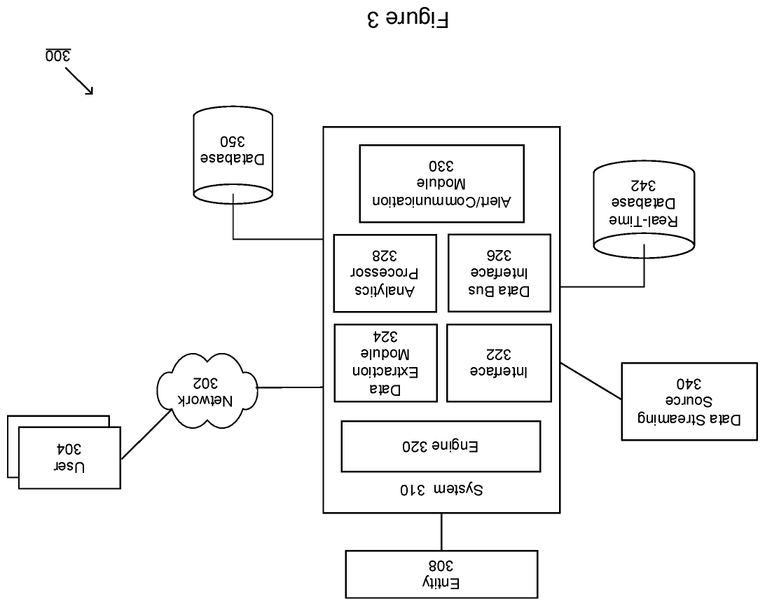

FIG. 3 is an exemplary system diagram, according to an embodiment of the present invention. FIG. 3 illustrates System 310 that addresses spear phishing and other attempts through a real-time database implementation. System 310 may identify filtered communications and extract data relating to financial directives to identify targeted accounts for one or more users, clients and/or customers, represented by 304. Engine 320 may include computer processors, servers and/or components including Interface 322, Data Extraction Module 324, Data Bus Interface 326 and Analytics Processor 328 and Alert/Communication Module 330.

Interface 322 may receive data streams from one or sources, such as data loss prevention systems, email detection systems, spam detection technology, etc. The data may be formatted in various formats and further normalized for consistency. Data Streaming Source 340 may represent data from a single entity as well as data sources across multiple entities. Data Extraction Module 324 may extract financial directive data, including account identifiers, routing data, payment instructions, etc. Data Bus Interface 326 may interact with Real-Time Database 342. Analytics Processor 328 may perform analytics on the extracted data for feedback purposes as well as identifying other potentially targeted accounts and users. Alert/Communication Module 330 may communicate alerts, warnings and/or other information to potentially targeted accounts, users, entities, corresponding financial institutions, etc.

Entity 308, such as a financial institution, may host System 310. Users may interact via Network 302. Users may include individual users, teams, Lines of Businesses and/or other entities. Users 304 may communicate with via Network 302 to access System 310 and Engine 320. Engine 320 may send and/or receive data from various data streaming sources, represented by 340. Databases 350 may store data relating to targeted accounts, financial directives, instructions, etc.

The system 300 of FIG. 3 may be implemented in a variety of ways. Architecture within system 300 may be implemented as hardware components (e.g., module) within one or more network elements. It should also be appreciated that architecture within system 300 may be implemented in computer executable software (e.g., on a tangible, non-transitory computer-readable medium) located within one or more network elements. Module functionality of architecture within system 300 may be located on a single device or distributed across a plurality of devices including one or more centralized servers and one or more mobile units or end user devices. The architecture depicted in system 300 is meant to be exemplary and non-limiting. For example, while connections and relationships between the elements of system 300 are depicted, it should be appreciated that other connections and relationships are possible. The system 300 described below may be used to implement the various methods herein, by way of example. Various elements of the system 300 may be referenced in explaining the exemplary methods described herein.

Network 302 may be a wireless network, a wired network or any combination of wireless network and wired network. For example, Network 302 may include one or more of an Internet network, a satellite network, a wide area network (“WAN”), a local area network (“LAN”), an ad hoc network, a Global System for Mobile Communication (“GSM”), a Personal Communication Service (“PCS”), a Personal Area Network (“PAN”), D-AMPS, Wi-Fi, Fixed Wireless Data, IEEE 802.11a, 802.11b, 802.15.1, 802.11g, 802.11n, 802.11ac, or any other wired or wireless network for transmitting or receiving a data signal. Also, Network 302 may support an Internet network, a wireless communication network, a cellular network, Bluetooth, or the like, or any combination thereof. Network 302 may further include one, or any number of the exemplary types of networks mentioned above operating as a stand-alone network or in cooperation with each other. Network 302 may utilize one or more protocols of one or more network elements to which it is communicatively coupled. Network 302 may translate to or from other protocols to one or more protocols of network devices. Although Network 302 is depicted as one network for simplicity, it should be appreciated that according to one or more embodiments, Network 302 may comprise a plurality of interconnected networks, such as, for example, a service provider network, the Internet, a cellular network, corporate networks, or even home networks, or any of the types of networks mentioned above.

Data may be transmitted and received via Network 302 utilizing a standard networking protocol or a standard telecommunications protocol. For example, data may be transmitted using Session Initiation Protocol (“SIP”), Wireless Application Protocol (“WAP”), Multimedia Messaging Service (“MMS”), Enhanced Messaging Service (“EMS”), Short Message Service (“SMS”), Global System for Mobile Communications (“GSM”) based systems, Code Division Multiple Access (“CDMA”) based systems, Transmission Control Protocol/Internet Protocols (“TCP/IP”), hypertext transfer protocol (“HTTP”), hypertext transfer protocol secure (“HTTPS”), real time streaming protocol (“RTSP”), or other protocols and systems suitable for transmitting and receiving data. Data may be transmitted and received wirelessly or in some cases may utilize cabled network or telecom connections such as an Ethernet RJ45/Category 5 Ethernet connection, a fiber connection, a cable connection or other wired network connection.

While FIG. 3 illustrates individual devices or components, it should be appreciated that there may be several of such devices to carry out the various exemplary embodiments. Users may communicate with various entities using any mobile or computing device, such as a laptop computer, a personal digital assistant, a smartphone, a smartwatch, smart glasses, other wearables or other computing devices capable of sending or receiving network signals.

System 310 may be communicatively coupled to Database 350. Database 350 may include any suitable data structure to maintain the information and allow access and retrieval of the information. For example, Database 350 may keep the data in an organized fashion and may be an Oracle database, a Microsoft SQL Server database, a DB2 database, a MySQL database, a Sybase database, an object oriented database, a hierarchical database, a flat database, and/or another type of database as may be known in the art to store and organize data as described herein. Database 350 may be any suitable storage device or devices. The storage may be local, remote, or a combination thereof with respect to Database 350. Database 350 may utilize a redundant array of disks (RAID), striped disks, hot spare disks, tape, disk, or other computer accessible storage. In one or more embodiments, the storage may be a storage area network (SAN), an internet small computer systems interface (iSCSI) SAN, a Fiber Channel SAN, a common Internet File System (CIFS), network attached storage (NAS), or a network file system (NFS). Database 350 may have back-up capability built-in. Communications with Database 350 may be over a network, or communications may involve a direct connection between Database 350 and Entity 308, as depicted in FIG. 3. Database 350 may also represent cloud or other network based storage.

The foregoing examples show the various embodiments of the invention in one physical configuration; however, it is to be appreciated that the various components may be located at distant portions of a distributed network, such as a local area network, a wide area network, a telecommunications network, an intranet and/or the Internet. Thus, it should be appreciated that the components of the various embodiments may be combined into one or more devices, collocated on a particular node of a distributed network, or distributed at various locations in a network, for example. As will be appreciated by those skilled in the art, the components of the various embodiments may be arranged at any location or locations within a distributed network without affecting the operation of the respective system.

As described above, the various embodiments of the present invention support a number of communication devices and components, each of which may include at least one programmed processor and at least one memory or storage device. The memory may store a set of instructions. The instructions may be either permanently or temporarily stored in the memory or memories of the processor. The set of instructions may include various instructions that perform a particular task or tasks, such as those tasks described above. Such a set of instructions for performing a particular task may be characterized as a program, software program, software application, app, or software.

It is appreciated that in order to practice the methods of the embodiments as described above, it is not necessary that the processors and/or the memories be physically located in the same geographical place. That is, each of the processors and the memories used in exemplary embodiments of the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two or more pieces of equipment in two or more different physical locations. The two distinct pieces of equipment may be connected in any suitable manner. Additionally, the memory may include two or more portions of memory in two or more physical locations.

As described above, a set of instructions is used in the processing of various embodiments of the invention. The servers may include software or computer programs stored in the memory (e.g., non-transitory computer readable medium containing program code instructions executed by the processor) for executing the methods described herein. The set of instructions may be in the form of a program or software or app. The software may be in the form of system software or application software, for example. The software might also be in the form of a collection of separate programs, a program module within a larger program, or a portion of a program module, for example. The software used might also include modular programming in the form of object oriented programming. The software tells the processor what to do with the data being processed.

Further, it is appreciated that the instructions or set of instructions used in the implementation and operation of the invention may be in a suitable form such that the processor may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processor, i.e., to a particular type of computer, for example. Any suitable programming language may be used in accordance with the various embodiments of the invention. For example, the programming language used may include assembly language, Ada, APL, Basic, C, C++, COBOL, dBase, Forth, Fortran, Java, Modula-2, Pascal, Prolog, REXX, Visual Basic, JavaScript and/or Python. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of various embodiments of the invention may utilize any compression or encryption technique or algorithm, as may be desired. An encryption module might be used to encrypt data. Further, files or other data may be decrypted using a suitable decryption module, for example.

In the system and method of exemplary embodiments of the invention, a variety of “user interfaces” may be utilized to allow a user to interface with the mobile devices or other personal computing device. As used herein, a user interface may include any hardware, software, or combination of hardware and software used by the processor that allows a user to interact with the processor of the communication device. A user interface may be in the form of a dialogue screen provided by an app, for example. A user interface may also include any of touch screen, keyboard, voice reader, voice recognizer, dialogue screen, menu box, list, checkbox, toggle switch, a pushbutton, a virtual environment (e.g., Virtual Machine (VM)/cloud), or any other device that allows a user to receive information regarding the operation of the processor as it processes a set of instructions and/or provide the processor with information. Accordingly, the user interface may be any system that provides communication between a user and a processor. The information provided by the user to the processor through the user interface may be in the form of a command, a selection of data, or some other input, for example.

The software, hardware and services described herein may be provided utilizing one or more cloud service models, such as Software-as-a-Service (SaaS), Platform-as-a-Service (PaaS), and Infrastructure-as-a-Service (IaaS), and/or using one or more deployment models such as public cloud, private cloud, hybrid cloud, and/or community cloud models.

Although the embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes.

What is claimed is:

1. A system that addresses spear phishing attempts, the system comprising:
an interface that receives blocked information from a plurality of accounts;
a real-time database that stores and manages blocked information; and
a computer server that is coupled to the interface and the real-time database and further configured to perform the steps of:
receiving results of blocked emails or communications from one or more data streaming sources;
identifying financial directions from the blocked emails or communications;
extracting account numbers and routing numbers from the financial directions;
publishing, via a real-time database, the extracted account numbers and routing numbers in real-time as topics onto a shared data bus;
enhancing the extracted account numbers and routing numbers with payloads and one or more details;
determining whether an instruction contains data that matches the extracted account numbers and routing numbers stored in the real-time database;
responsive to determining whether the instruction contains matched data, alerting one or more associated users of a potential attack; and
performing analytics on the extracted account numbers and routing numbers.

2. The system of claim 1, wherein the real-time database is SnapCache.

3. The system of claim 1, wherein the financial directions comprise wire instructions.

4. The system of claim 1, wherein the financial directions comprise automated clearing house (ACH) instructions.

5. The system of claim 1, wherein the one or more details comprise corresponding headers and payloads.

6. The system of claim 1, wherein the financial directions comprise security data requests.

7. The system of claim 1, wherein the financial directions comprise personal identifiable information.

8. The system of claim 1, wherein the one or more data streaming sources comprise data loss prevention systems.

9. The system of claim 1, wherein the one or more data streaming sources comprise a filter for unsolicited and unwanted email communications.

10. The system of claim 1, wherein the extracted information is further processed for analysis and feedback.

11. A method that addresses spear phishing, the method comprising the steps of:
receiving, via an interface, results of blocked emails or communications from one or more data streaming sources;
identifying, via a computer server, financial directions from the blocked emails or communications;
extracting, via the computer server, account numbers and routing numbers from the financial directions;
publishing, via a real-time database, the extracted account numbers and routing numbers in real-time as topics onto a shared data bus;
enhancing, via the computer server, the extracted account numbers and routing numbers with payloads and one or more details;
determining, via the computer server, whether an instruction contains data that matches the extracted account numbers and routing numbers stored in the real-time database;
responsive to determining whether the instruction contains matched data, alerting one or more associated users of a potential attack; and
performing, via the computer server, analytics on the extracted account numbers and routing numbers.

12. The method of claim 11, wherein the real-time database is SnapCache.

13. The method of claim 11, wherein the financial directions comprise wire instructions.

14. The method of claim 11, wherein the financial directions comprise automated clearing house (ACH) instructions.

15. The method of claim 11, wherein the one or more details comprise corresponding headers and payloads.

16. The method of claim 11, wherein the financial directions comprise security data requests.

17. The method of claim 11, wherein the financial directions comprise personal identifiable information.

18. The method of claim 11, wherein the one or more data streaming sources comprise data loss prevention systems.

19. The method of claim 11, wherein the one or more data streaming sources comprise a filter for unsolicited and unwanted email communications.

20. The method of claim 11, wherein the extracted information is further processed for analysis and feedback.
